(19) United States
(12) Patent Application Publication
(10) Pub. No.: US 2008/0179391 A1
(43) Pub. Date: Jul. 31, 2008

(54) METHOD FOR MONITORING PREPARATION OF ITEMS TO BE MAILED

(75) Inventors: Jelle WIERSMA, Drachtster Compagnie (NL); Hendrik Cornelis FIJNVANDRAAT, Enschede (NL)

Correspondence Address: SUGHRUE MION, PLLC, 2100 PENNSYLVANIA AVENUE, N.W., SUITE 800, WASHINGTON, DC, 20037, US

(73) Assignee: NEOPOST TECHNOLOGIES, Bagneux (NL)

(21) Appl. No.: 12/023,503

(22) Filed: Jan. 31, 2008

(30) Foreign Application Priority Data
Jan. 31, 2007 (EP) 07002071.4

(51) Int. Cl. G06K 17/00

(52) U.S. Cl. 235/375

(57) ABSTRACT

The invention relates to a method for monitoring the printing and transport of documents through a system for preparing items to be mailed. The method comprises obtaining a reference code for the documents from a file on the basis of which the respective document has been printed, transporting the printed documents through the system, obtaining an image from the printed document in a location in the system for obtaining an image data set representing the obtained image, comparing each of the image data sets with at least one of the reference codes, and in response to the image data set and the at least one compared reference code not matching, generating a warning. The reference codes are compared with associated image data sets in an order corresponding to the order or to an inversion of the order in which the documents have been printed.

### FIELD AND BACKGROUND OF THE INVENTION

The invention relates to a method for monitoring preparation of items to be mailed. In the course of preparing items to be mailed, for example when combining multiple documents into mail pieces, faults may occur such as sheets missing or being added multiple times due to for example double feeds from a printer bin, sheets missing after printer crashes and printer overflows, etc. By monitoring the transport of the documents, it can be checked if the items to be mailed are composed of the correct documents.

U.S. Pat. No. 6,988,349 describes a method for preparing mail pieces, in which mail piece ID's are printed on the documents. When an inserter system begins processing a mail run, the inserter system scans the barcode of each document being processed and the inserter system controller requests a data block based on a mail run data file ID and the scanned mail piece ID and the data block is allocated except when the mail piece ID is not correct or because the mailpiece ID is a duplicate to one previously processed in the mail run. Damaged and missing mail pieces are reported back and at the end of mail piece processing mail pieces not processed for the mail run are identified.

A drawback of such a method is that it requires the generation of ID codes for the mail pieces, which have to be incorporated into the documents and printed.

U.S. Pat. No. 5,956,414 describes a method for monitoring and controlling processes in the field of the further processing of products of e.g. printing. When a stream of products is processed, recording an actual image of a product is started, followed by reading an actual image using an image processing module and comparing the actual image to a reference image, concluded by generating a control signal in response to the result of the comparison and an operating state of the image processing module. In this way a machine can automatically select the correct steps for the further processing. A drawback of this is that when multiple image processing modules are used, the overall operating state of the machine is determined by the state of the different modules and this complicates control when products have to be processed in a predetermined order.

### SUMMARY OF THE INVENTION

It is an object of the present invention to monitor the processing of mutually different documents into items to be mailed, which does not require the provision and printing of mail piece ID's.

This object is achieved by providing a method for monitoring preparation of items to be mailed, consisting of printing documents; obtaining a reference code for each of at least a plurality of the printed documents from a file on the basis of which the respective document has been printed; transporting the printed documents through a system for preparing items to be mailed; obtaining an image from at least a plurality of the printed documents in at least one location in the system so that an image data set is obtained for each of the plurality of documents; comparing each of the image data sets with at least one of the reference codes; and in response to the image data set and the at least one compared reference code not matching, generating a warning, wherein the reference codes are compared with associated image data sets in an order corresponding to the order or to an inversion of the order in which the documents have been printed.

Because the reference codes are each a representation of an image of at least a portion of the associated printed document, a mail piece ID code is not necessary for comparing data obtained from a document with the reference code to determine whether the data match the reference code. By comparing the obtained reference codes with image data sets obtained from the printed documents in an order corresponding to the order or to an inversion of the order in which the documents have been printed, the reference codes can be compared with the obtained image data sets efficiently, because the order of the reference codes and the order of the image data sets determines with which one of the image data sets each reference is to be compared and vice versa.

Particular elaborations and methods of the invention are set forth in the dependent claims.

Further features, effects and details of the invention appear from the detailed description and the drawings.

### BRIEF DESCRIPTION OF THE DRAWINGS

FIG. 1 is a flowchart of an example of a method according to the invention;

FIG. 2 is a schematic representation of a mailing system in which a method according to the invention can be applied; and

FIG. 3 is portion of a table comprising reference codes, order data and associated files on basis of which documents have been printed.

### DETAILED DESCRIPTION

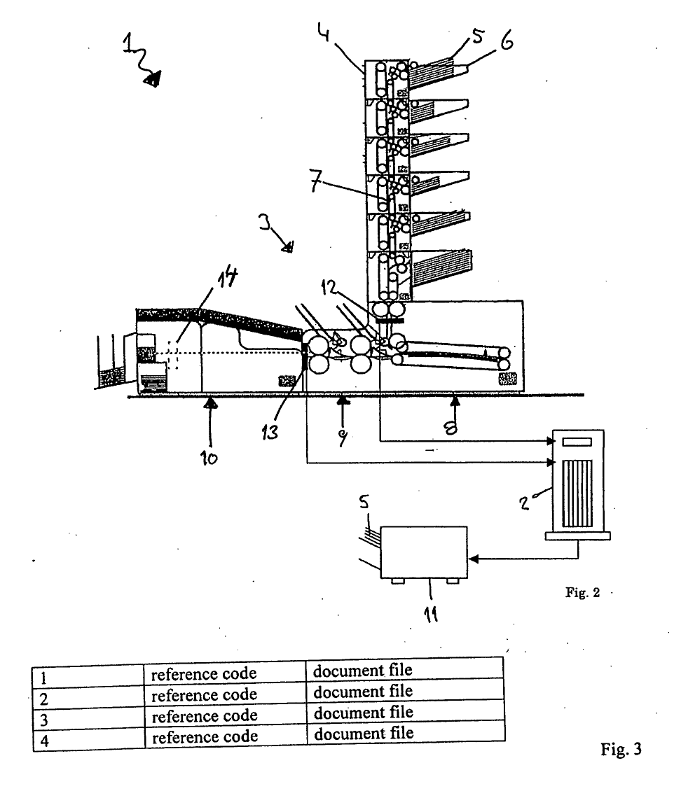

In FIG. 2, a system 1 is shown in that is composed of a computer 2, a printer 11, and a mail preparation apparatus 3.

For preparing items to be mailed, documents are printed on the printer 11 on basis of a print stream received from the computer 2. The printed documents are accumulated into a stack 5 which is subsequently loaded into the apparatus 3 and processed by the apparatus 3.

The apparatus 3 is equipped with a plurality of feeding stations 4 for individually feeding documents from a stack 5 in document storage 6. In FIG. 2 only a topmost one of the feeding stations is designated by reference numerals. The feeding stations 4 are combined with conveyors. The conveyors of the successive feeding stations 4 form an upstream portion of a document transport path 7.

Downstream of the feeding stations 4, a first scanner 12 is arranged along the transport track 7 for obtaining images from the passing documents by scanning the passing documents.

Downstream of the first scanner 12, the transport track 7 leads to an aligning station 8 for aligning transported documents that are gathered into a stack having substantially aligned document edges on one side. The aligning station has a discharge track forming a further section of the transport track 7 leading to a folding station 9 for folding documents arriving from the aligning station 8.

An inserting station 10 forms the next station downstream of the folding station 9 and is arranged for inserting folded documents and folded sets of documents that arrive from the folding station 9 from into envelopes.

A second scanner 13 for scanning the transported documents is positioned along the transport path 7 just upstream of an entry of the inserting station 10. A third scanner 14 for scanning envelopes after documents have been inserted therein is positioned along the transport path 7 in the inserter 10. The third scanner 14 may scan portions of the documents that are visible through the envelope window or envelope windows, typically showing the address information or addresses printed on the envelopes. The first and second scanners 12, 13, are preferably arranged for scanning substantially the entire surfaces of the documents.

The scanners 12, 13, 14 are connected to the computer for allowing the scanning results to be transmitted from the scanners 12, 13, 14 to the computer 2 for monitoring the transport of documents through the mail preparation apparatus 3.

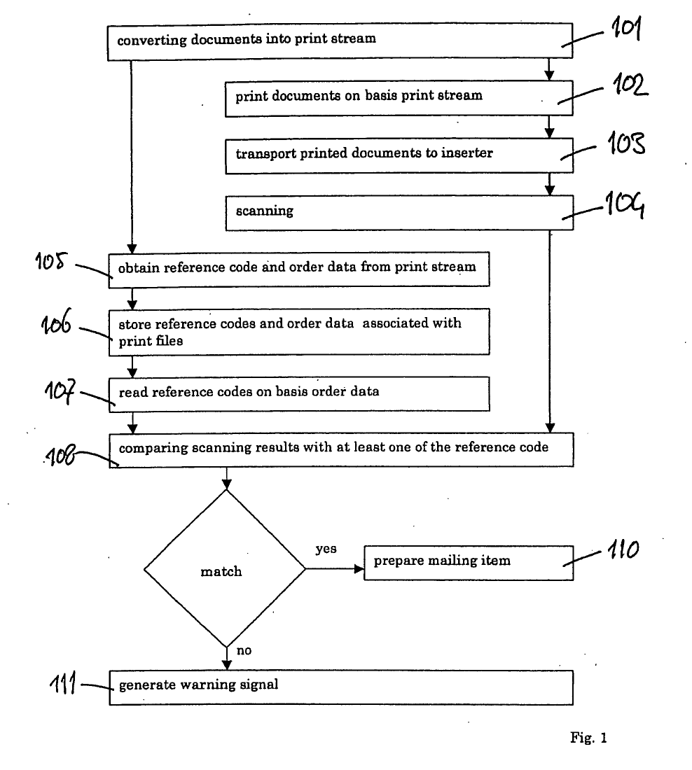

FIG. 1 shows a flowchart of a method for monitoring the transport of documents through the apparatus 3 shown in FIG. 2.

For preparing for example a mailing, digital documents are generated and standard documents to be added as enclosures are selected. The digital documents are converted into a print stream containing document files (step 101). The print stream is passed from the computer 2 to the printer 11, which prints the documents (step 102) in accordance with instructions in the print stream. The printed documents are gathered in a stack in an order corresponding to the order of printing.

The computer 2 determines reference codes for the documents from the print stream on the basis of which the documents are printed (step 105). This may be carried out before, during and/or after the actual printing of the documents.

In the present example, the reference codes are obtained from the print stream. It is also possible to obtain the reference codes from for example a file in a word processing format that has been processed into the print stream.

References codes are obtained for each of at least a plurality of the documents. For example, a reference code may be obtained for all the printed documents, or only for the main documents of each set of printed documents, such as the first and/or the last document of a set.

As a reference code, an image file, representing an image of the associated printed document, is created on basis of the print stream. For creating an image file that allows a document to be recognized or at least distinguished from some of the preceding and succeeding documents, no information has to be added to the document file, the print file, or the printed document.

From the print stream, also information on the order in which the documents are printed (step 106) is obtained. These order data are stored by the computer 2 (step 106) in association with the reference data. The reference codes may for example be stored in a table in the order corresponding to the order of the files in the print stream from which the reference codes have been derived, and, accordingly, in the order in which the documents are printed.

For preparing items to be mailed, the documents printed by the printer 11 are placed in a hopper 6 of a feeding station 4. The printed documents are each separated from the stack 5 and transported along the transport path 7 in succession in an order corresponding to the order in which the documents have been printed. The documents each pass from the feeder station 4, to the aligning station 8, where the documents may be gathered with other documents from the same or other feeding stations. The documents then pass to the folding station 9 where they may be folded to the inserting station 10 (step 103) where each document or set of documents is inserted into an envelope.

When the documents pass the scanners 12, 13, 14 images are scanned from at least some of the documents. For example, all the printed documents, or only the main documents of a set of printed documents, such as the first and/or last document of a series of documents may be scanned. It may also be provided that the scanner scans all the documents and the computer only compares some of the scanning results with the associated reference codes.

The reference codes stored by the computer 2 are read in an order in accordance with the order data (step 107) and compared with associated scanning results received by the computer 2 (step 108) in an order corresponding to the order or to an inversion of the order in which the documents have been printed. By comparing the reference codes with the scanning results it is checked if all the documents of the mailing and only those documents have passed the scanner.

The order in which the reference codes are compared with the associated scanning results corresponds to the order or to an inversion of the order in which the documents have been printed. For example a specific series of documents may be printed in a reversed order, that is, the last document of the series first, and the first document of the series last, for obtaining a printed stack of documents with the first document on top instead of at the bottom of the stack and/or the stack may have been inverted for processing of the documents in the mail preparation apparatus 3.

By comparing reference codes with the scanning results in the order or an inversion of the order in which the documents have been printed, each reference code needs to be compared with the scanning result it is supposed to match with only. This is of particular importance for the comparison of image data on the basis of which selection of a best matching reference code from a large number of reference codes would be relatively difficult.

If the reference codes and the associated scanning results match, the mail pieces are supposed to be composed of the correct documents and the preparation of the mail piece is allowed to proceed (step 110).

In response to a scanning result and reference code not matching, a warning is generated (step 111). The warning may for example be generated in the form of a visual or audible signal indicating an operator there is a problem with the item to be mailed. Furthermore, the process of preparing items to be mailed may be stopped, and/or the document(s) associated with the warning signal may be diverted to an exit for faulty mail pieces.

In response to one of the scanning results and the associated one of the reference codes not matching, a next one of the reference codes may also be compared with the scanning result. In response to a match between the next reference code and the scanning result, a warning indicating the absence of the document associated to the non matching reference code may be generated, which is preferably different from a warning where no match was found at all.

An image corresponding to a non-matching reference code may be displayed or printed. Since the reference code is an image of the associated printed document, it can be used for making the image of the associated document visible on a printer or display, which is for example helpful for an operator attempting to resolve problems due to an operating error.

For enabling printing the document associated with a reference code, in a preferred method, the reference code is associated to data identifying a printable file for printing the associated document. By using a printable file for printing the document instead of the reference code, data loss due to for example a low resolution of the reference code may be compensated.

The reference code may for instance be stored in a table in combination with the associated document file or a link to the associated document file. FIG. 3 shows an example of a table for memorizing such associated information. The table groups the information associated to printed documents in rows. The first column comprises the order data, the second column the reference codes, and the third column the associated files on basis of which the documents have been printed.

In an alternative method, specific data in the image making up the reference code can be used, by for example optically analyzing the image, for locating and/or generating a print file. For example, information identifying the type of document and/or specific information such as the address on the document can be obtained, and subsequently used for locating and/or generating a document to be printed.

In an alternative method according to the invention, the print file and the reference code are both determined directly from a common document file.

A reference code in the form of data representing an image can be obtained in a simple manner from the file on basis of which the document is printed and from the file produced by a scanner. An image can for example be obtained by printing a word processing file to an image file for example using software such as Proforma Infinitec.

The efficiency of the monitoring process can be increased by obtaining a reference code and/or a scanning result of a selection of the printed documents only, and/or by comparing a selection of the scanned documents with the associated reference codes only. For example only the reference codes of the main documents of a set of printed documents may be obtained, and compared with the associated scanning results. Furthermore, image scanned from portions of the printed documents may be compared with corresponding portions of the images generated on basis of the document file or the print file. For example, the computer may comprise software enabling an operator to indicate on the reference code image an area such as the area comprising the address, the first paragraph of text, or the order of certain images in a text or document, etc. for matching with the associated scanning result. Thus only specific parts of the document have to be compared with the reference code.

Software for setting folding systems to fold documents such that the address ends up behind the address window of the envelope, may be used for determining which portion of the documents is to be scanned and/or used as a reference code. This is particularly advantageous for the scanning of documents after insertion into the envelope using a scanner such as the scanner 14 in FIG. 2.

It is also possible to use a scanning as a reference code. For example, a scanning result of the scanner 12 suspended along the transport track 7 downstream of the feeding stations, may be compared with the scanning result of the scanner 13 scanning the documents transported into the inserter 10. This allows monitoring the transport of documents where a file on basis of which a document was printed is not available.

Other variations to the disclosed embodiments can be understood and effected by those skilled in the art in practicing the claimed invention, from a study of the drawings, the disclosure, and the appended claims. For instance, for obtaining image data also another imaging device than a scanner may be used, such as a digital camera.

1. A method for monitoring preparation of items to be mailed, comprising:
printing documents;
obtaining a reference code for each of at least a plurality of the printed documents from a file on the basis of which the respective document has been printed;
transporting the printed documents through a system for preparing items to be mailed;
obtaining an image from at least a plurality of the printed documents in at least one location in the system so that an image data set is obtained for each of the plurality of documents;
comparing each of the image data sets with at least one of the reference codes; and
in response to the image data set and the at least one compared reference code not matching, generating a warning, wherein the reference codes are compared with associated image data sets in an order corresponding to the order or to an inversion of the order in which the documents have been printed.

2. A method according to claim 1, wherein reference codes are obtained for main documents of sets of the printed documents only.

3. A method according to claim 1, wherein in response to one of the image data sets and the associated one of the reference codes not matching, a next one of the reference codes is also compared with said image data set and wherein, in response to a match between said next reference code and said scanning result, a warning indicating the absence of the document associated to the non matching reference code is generated.

4. A method according to claim 1, wherein in response to the warning an image corresponding to said non-matching reference code is displayed or printed.

5. A method according to claim 1, wherein the reference code is associated to data identifying a printable file for printing the associated printed document.

6. A method according to claim 1, wherein the documents are printed in accordance with printing instructions in a print file and wherein the print file and the reference code have been obtained by processing document data from a common document file.
